(19) United States
(12) Patent Application Publication
(10) Pub. No.: US 2026/0084650 A1
(43) Pub. Date: Mar. 26, 2026

(54) VEHICLE CONTROL DEVICE

(71) Applicant: TOYOTA JIDOSHA KABUSHIKI KAISHA, Toyota-shi (JP)

(72) Inventors: Hiroki TAKEISHI, Machida-shi (JP); Reina YAMAMURA, Nagoya-shi (JP); Ryosuke TANIMURA, Nagoya-shi (JP)

(73) Assignee: TOYOTA JIDOSHA KABUSHIKI KAISHA, Toyota-shi (JP)

(21) Appl. No.: 19/304,207

(22) Filed: Aug. 19, 2025

(30) Foreign Application Priority Data
Sep. 25, 2024 (JP) 2024-166473

(51) Int. Cl. B60R 25/045; B60R 25/33; G06Q 40/03; B60R 25/04

(52) U.S. Cl. CPC B60R 25/045; B60R 25/33; G06Q 40/038; B60R 2025/0405; B60R 2325/10

(57) ABSTRACT

A processor of a vehicle control device: acquires regular vehicle stop position information indicating a regular vehicle stop position of a vehicle from a database that stores history information on a vehicle stop position of the vehicle; when it is detected that the vehicle has stopped, requests latest position information on the vehicle; acquires the latest position information on the vehicle; when the vehicle meets a prespecified requirement for engine start lock, determines whether to activate the engine start lock of the vehicle by at least comparing the regular vehicle stop position information and the latest position information; and when it is determined to activate the engine start lock, activates the engine start lock.

### CROSS-REFERENCE TO RELATED APPLICATION

This application claims priority to Japanese Patent Application No. 2024-166473 filed on September 25, 2024. The disclosure of the above-identified application, including the specification, drawings, and claims, is incorporated by reference herein in its entirety.

### BACKGROUND

### Technical Field

This disclosure relates to a vehicle control device.

### Description of Related Art

Japanese Patent No. 6647509 (JP 6647509 B) discloses a technology by which an individual or a corporation (e.g., an owner of a vehicle) other than a user of the vehicle executes engine start lock for reasons of credit protection or safety. For the engine start lock, to ensure the user's safety, conditions for activating the engine start lock are provided, such as that a current position of the vehicle is a specific place and that the vehicle is not traveling.

### SUMMARY

The technology disclosed in JP 6647509 B has difficulty executing the engine start lock by accurately determining, for example, whether the vehicle is in a state of not being used, and thus has room for improvement in terms of ensuring the user's safety.

This disclosure provides a vehicle control device that performs determination on activation of engine start lock while ensuring the safety of a user of the vehicle.

A vehicle control device according to an aspect of this disclosure includes a processor. The processor is configured to: acquire regular vehicle stop position information indicating a regular vehicle stop position of a vehicle from a database configured to store history information on a vehicle stop position of the vehicle; when it is detected that the vehicle has stopped, request latest position information on the vehicle; acquire the latest position information on the vehicle; when the vehicle meets a prespecified requirement for engine start lock, determine whether to activate the engine start lock of the vehicle by at least comparing the regular vehicle stop position information and the latest position information; and when it is determined to activate the engine start lock, activate the engine start lock.

This disclosure makes it possible to perform determination on activation of engine start lock while ensuring the safety of a user of the vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing the general configuration of a vehicle control system including a vehicle control device according to an embodiment;

FIG. 2 is a sequence chart showing one example of exchange of information among a credit collection server, a vehicle information server, and a vehicle;

FIG. 3 is a flowchart showing one example of the flow of a process in the credit collection server that functions as the vehicle control device according to the embodiment;

FIG. 4 is a flowchart showing one example of a flow in the vehicle information server when transmitting vehicle position information to the credit collection server;

FIG. 5 is a flowchart showing one example of a flow in the vehicle information server when performing activation of engine start lock;

FIG. 6 is a flowchart showing one example of a flow in the vehicle when transmitting the vehicle position information to the vehicle information server;

FIG. 7 is a flowchart showing one example of a flow in the vehicle when performing activation of the engine start lock;

FIG. 8 is a flowchart showing one example of a flow in a vehicle history DB when creating regular vehicle stop position information; and

FIG. 9 is a flowchart showing one example of a flow in the vehicle history DB when transmitting the regular vehicle stop position information to a control unit.

### DETAILED DESCRIPTION OF EMBODIMENTS

A vehicle control device according to an embodiment of this disclosure will be described with reference to the drawings. Constituent elements in the following embodiment include those that a person skilled in the art can easily substitute, or those that are substantially the same.

### Vehicle Control System

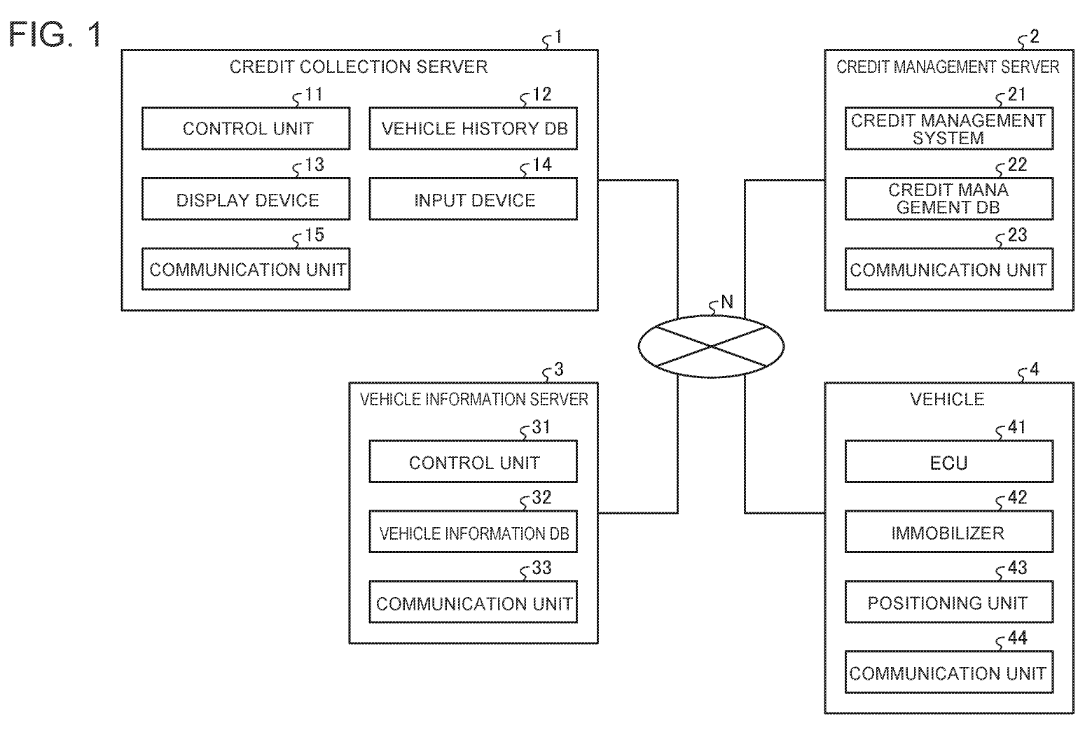

A vehicle control system according to the embodiment will be described with reference to FIG. 1. As shown in FIG. 1, the vehicle control system has a credit collection server 1, a credit management server 2, a vehicle information server 3, and a vehicle 4. The credit collection server 1, the credit management server 2, the vehicle information server 3, and the vehicle 4 each include a communication function, and are configured to be able to exchange various pieces of information by communicating with one another through a network N. The network N is formed by, for example, a public line network, such as an Internet network or a mobile phone network. In the vehicle control system according to the embodiment, the credit collection server 1 functions as a vehicle control device that controls operation (particularly engine start lock) of the vehicle 4.

### Credit Collection Server

The credit collection server 1 remotely controls the vehicle 4 to collect a credit relating to the vehicle 4. In this embodiment, examples of "credit" include a credit relating to an installment contract at the time of purchase of a vehicle, a credit relating to a lease contract of the vehicle 4, a credit relating to a subscription contract of the vehicle 4, and a credit relating to a rental contract of the vehicle 4.

A creditor in this embodiment is, for example, an owner (possessor) of the vehicle 4. Examples of the creditor include a dealer of the vehicle 4 and a credit company. A debtor in this embodiment is, for example, a user of the vehicle 4. Examples of the debtor include a purchaser of the vehicle 4 and a party to a contract, such as a lease contract.

As shown in FIG. 1, the credit collection server 1 includes a control unit 11, a vehicle history DB 12, a display device 13, an input device 14, and a communication unit 15.

The control unit 11 is realized by, for example, a processor that is formed by a central processing unit (CPU) or the like and a memory (main storage unit) that is formed by a random access memory (RAM), a read-only memory (ROM), or the like. When the vehicle 4 meets a prespecified requirement for the engine start lock (hereinafter referred to as "engine start lock requirement"), the control unit 11 acquires predetermined information from the vehicle history DB 12 and the vehicle information server 3 and determines whether to activate the engine start lock based on these pieces of information.

Examples of "engine start lock requirement" include that the user of the vehicle 4 defaults on a debt (is late in payment). Determination as to whether this engine start lock requirement is met is performed, for example, in the credit management server 2. When there is a vehicle 4 that meets the engine start lock requirement, information for identifying that vehicle 4 (e.g., a vehicle identification number (VIN number)) is transmitted from the credit management server 2 to the credit collection server 1.

In preceding technologies, engine start lock is activated when the above-described engine start lock requirement is met and, moreover, a current position of the vehicle is a specific place, the vehicle is not traveling, etc. On the other hand, in this embodiment, the engine start lock of the vehicle 4 is remotely activated when the engine start lock requirement is met and, moreover, the vehicle 4 is stationary at a regular vehicle stop position, such as at home or workplace.

Specifically, the control unit 11 acquires information about the vehicle 4 that meets the engine start lock requirement from a credit management system 21 of the credit management server 2. Subsequently, the control unit 11 acquires regular vehicle stop position information indicating a regular vehicle stop position of that vehicle 4 from the vehicle history DB 12. This regular vehicle stop position information is information about, for example, a position at which the vehicle 4 has stopped a predetermined number of times or more times within a predetermined period, and specifically refers to coordinates (latitude and longitude) that indicate that position. For example, when the vehicle 4 is used as a private car, coordinates indicating the position of a parking place at home, a place of work, etc. constitute the regular vehicle stop position information. The regular vehicle stop position information is created beforehand based on, for example, position information on the vehicle 4 (hereinafter referred to as "vehicle position information") that is stored in the vehicle history DB 12 on a regular basis.

Alternatively, the regular vehicle stop position information may be information about a position that has been pre-registered by the user or the owner of the vehicle 4 through a separate information processing terminal (e.g., a personal computer or a smartphone). In this case, when coordinates corresponding to the regular vehicle stop position have been registered by the user or the owner of the vehicle 4, these coordinates are used as they are as the regular vehicle stop position information. On the other hand, when an address corresponding to the regular vehicle stop position has been registered by the user or the owner of the vehicle 4, this address is converted into coordinates, which are used as the regular vehicle stop position information.

Subsequently, when the control unit 11 detects that the vehicle 4 has stopped, the control unit 11 issues a request for the latest position information on the vehicle 4 (hereinafter referred to as "latest vehicle position information") to the vehicle information server 3, and acquires the latest vehicle position information from the vehicle information server 3. "When ... detects that the vehicle 4 has stopped" refers to, for example, when a signal indicating that the vehicle 4 has stopped and information about the vehicle stop position of the vehicle 4 (hereinafter referred to as "vehicle stop position information") have been transmitted from the vehicle information server 3 to the credit collection server 1. This vehicle stop position information is automatically transmitted from the vehicle 4 to the vehicle information server 3, for example, when the vehicle 4 has stopped and an ignition has turned off (IG-OFF).

Subsequently, when the vehicle 4 meets the engine start lock requirement (e.g., the user defaulting on a debt), the control unit 11 at least compares the regular vehicle stop position information and the latest position information on the vehicle 4. Thus, it is determined whether to activate the engine start lock of the vehicle 4. When the control unit 11 determines to activate the engine start lock, the control unit 11 activates the engine start lock by controlling an immobilizer 42 of the vehicle 4 through the vehicle information server 3.

Here, determining whether to activate the engine start lock may include determining to activate the engine start lock of the vehicle 4 when the regular vehicle stop position information and the latest vehicle position information are within a predetermined range. That is, the control unit 11 may determine to activate the engine start lock of the vehicle 4 when the coordinates indicated by the regular vehicle stop position information and the coordinates indicated by the latest vehicle position information are included within the predetermined range, in addition to when these coordinates are the same.

Being "within the predetermined range" mentioned above can be determined based on, for example, an error that is expected to be included in the regular vehicle stop position information and the latest vehicle position information. That is, the regular vehicle stop position information and the latest vehicle position information are detected by a positioning unit 43 of the vehicle 4 as will be described later, and these pieces of position information sometimes include a predetermined detection error. Therefore, the control unit 11 takes this detection error into account when comparing the regular vehicle stop position information and the latest vehicle position information, and thus determines whether to permit activation of the engine start lock based on whether these two pieces of position information are within the predetermined range.

Thus, the credit collection server 1 remotely activates the engine start lock of the vehicle 4 when the engine start lock requirement is met and, moreover, the vehicle 4 is stationary at a regular vehicle stop position, such as at home or workplace. Therefore, determination on activation of the engine start lock of the vehicle 4 can be more safely performed.

Here, detecting that the vehicle 4 has stopped may include receiving, from the vehicle information server 3, a signal indicating that the vehicle 4 has stopped and the vehicle stop position information indicating a position at which the vehicle 4 has stopped. Further, determining whether to activate the engine start lock may include determining to activate the engine start lock when the regular vehicle stop position information, the latest vehicle position information, and the vehicle stop position information are within the predetermined range.

That is, the control unit 11 may determine to activate the engine start lock of the vehicle 4 when the coordinates indicated by the regular vehicle stop position information, the coordinates indicated by the latest vehicle position information, and the coordinates indicated by the vehicle stop position information are included within the predetermined range.

Thus, the credit collection server 1 activates the engine start lock of the vehicle 4 when the vehicle 4 is stationary at a regular vehicle stop position, such as at home or workplace, and, moreover, the vehicle 4 remains stationary from when stopping of the vehicle 4 has been detected until present. Therefore, determination on activation of the engine start lock of the vehicle 4 can be more safely performed.

Here, timings at which the control unit 11 acquires the regular vehicle stop position information, and the vehicle stop position information and the latest position information on the vehicle 4 are not particularly limited.

For example, the control unit 11 may acquire the regular vehicle stop position information by issuing a request to the vehicle history DB 12 on a fixed cycle, or may acquire it by issuing a request to the vehicle history DB 12 with meeting of the engine start lock requirement as a trigger. Or the control unit 11 may acquire the regular vehicle stop position information by issuing a request to the vehicle history DB 12 with acquisition of the vehicle stop position information or the latest vehicle position information as a trigger.

The control unit 11 may acquire the vehicle stop position information by issuing a request to the vehicle information server 3 on a fixed cycle, or may acquire it by issuing a request to the vehicle information server 3 with meeting of the engine start lock requirement as a trigger. Or the control unit 11 may acquire the vehicle stop position information by issuing a request to the vehicle information server 3 with acquisition of the regular vehicle stop position information or the latest vehicle position information as a trigger.

The control unit 11 may acquire the latest vehicle position information by issuing a request to the vehicle information server 3 on a fixed cycle, or may acquire it by issuing a request to the vehicle information server 3 with meeting of the engine start lock requirement as a trigger. Or the control unit 11 may acquire the latest vehicle position information by issuing a request to the vehicle information server 3 with acquisition of the regular vehicle stop position information or the vehicle stop position information as a trigger.

The vehicle history DB 12 is one example of the database that stores various pieces of information about the vehicle 4. For example, the vehicle history DB 12 acquires the vehicle position information and the vehicle stop position information from the vehicle information server 3 and stores these pieces of information. The vehicle history DB 12 creates the regular vehicle stop position information based on the vehicle position information stored in the vehicle history DB 12.

The display device 13 is realized by, for example, a liquid crystal display (LCD) or an organic EL display (OLED). The input device 14 is realized by, for example, a keyboard or a pointing device.

The communication unit 15 is composed of, for example, a local area network (LAN) interface board, a wireless communication circuit for wireless communication, etc. The communication unit 15 exchanges information with the credit management server 2 and the vehicle information server 3 through communication via the network N.

### Credit Management Server

The credit management server 2 serves to manage a credit relating to the vehicle 4. As shown in FIG. 1, the credit management server 2 includes the credit management system 21, a credit management DB 22, and a communication unit 23.

When there is a vehicle 4 that meets the engine start lock requirement among the vehicles 4 managed by the credit management DB 22, the credit management system 21 transmits information for identifying that vehicle 4 (e.g., the vehicle identification number (VIN number)) to the credit collection server 1.

The credit management DB 22 stores the information for identifying the vehicle 4 (e.g., the vehicle identification number (VIN number)) and information about a credit for the vehicle 4 (e.g., a loan credit or a lease credit).

The communication unit 23 is composed of, for example, an LAN interface board, a wireless communication circuit for wireless communication, etc. The communication unit 23 exchanges information with the credit collection server 1 through communication via the network N.

### Vehicle Information Server

The vehicle information server 3 includes a control unit 31, a vehicle information DB 32, and a communication unit 33.

The control unit 31 is realized by, for example, a processor that is formed by a CPU or the like and a memory (main storage unit) that is formed by an RAM, an ROM, or the like. According to a request from the credit collection server 1, the control unit 31 acquires the vehicle position information from the vehicle 4 and transmits the acquired vehicle position information to the credit collection server 1. According to a request from the credit collection server 1, the control unit 31 transmits the vehicle stop position information acquired from the vehicle 4 to the credit collection server 1.

The vehicle information DB 32 stores the vehicle position information and the regular vehicle stop position information acquired from the vehicle 4. According to a request from the credit collection server 1, the vehicle information DB 32 transmits the regular vehicle stop position information to the credit collection server 1.

The communication unit 33 is composed of, for example, an LAN interface board, a wireless communication circuit for wireless communication, etc. The communication unit 33 exchanges information with the credit collection server 1, the credit management server 2, and the vehicle 4 through communication via the network N.

### Vehicle

The vehicle 4 is, for example, an ordinary engine vehicle (conventional vehicle), a hybrid electric vehicle (HEV), or a plug-in hybrid electric vehicle (PHEV). Or the vehicle 4 may be, for example, a fuel-cell electric vehicle (FCEV) or a battery electric vehicle (BEV). The vehicle 4 includes an ECU 41, the immobilizer 42, the positioning unit 43, and a communication unit 44.

The ECU 41 is an electronic control unit having, for example, a microcomputer composed of a CPU, an ROM, an RAM, etc. as a main component. According to a request from the vehicle information server 3, the ECU 41 transmits the vehicle position information to the vehicle information server 3. When the vehicle 4 has stopped and the ignition has turned off (IG-OFF), the ECU 41 transmits the vehicle stop position information to the vehicle information server 3.

The immobilizer 42 performs activation of the engine start lock or cancelation of the activation of the engine start lock based on control by the vehicle information server 3.

The positioning unit 43 detects a current position of the vehicle 4 by, for example, receiving electric waves from GPS satellites. The method for detecting the current position of the vehicle 4 is not limited to the method using the GPS satellites, and, for example, a method combining light detection and ranging/laser imaging detection and ranging (LiDAR) and a 3D map may be used.

The communication unit 44 is composed of, for example, a data communication module (DCM) etc. The communication unit 44 exchanges information with the vehicle information server 3 through communication via the network N.

### Exchange of Information among Credit Collection Server, Vehicle Information Server, and Vehicle

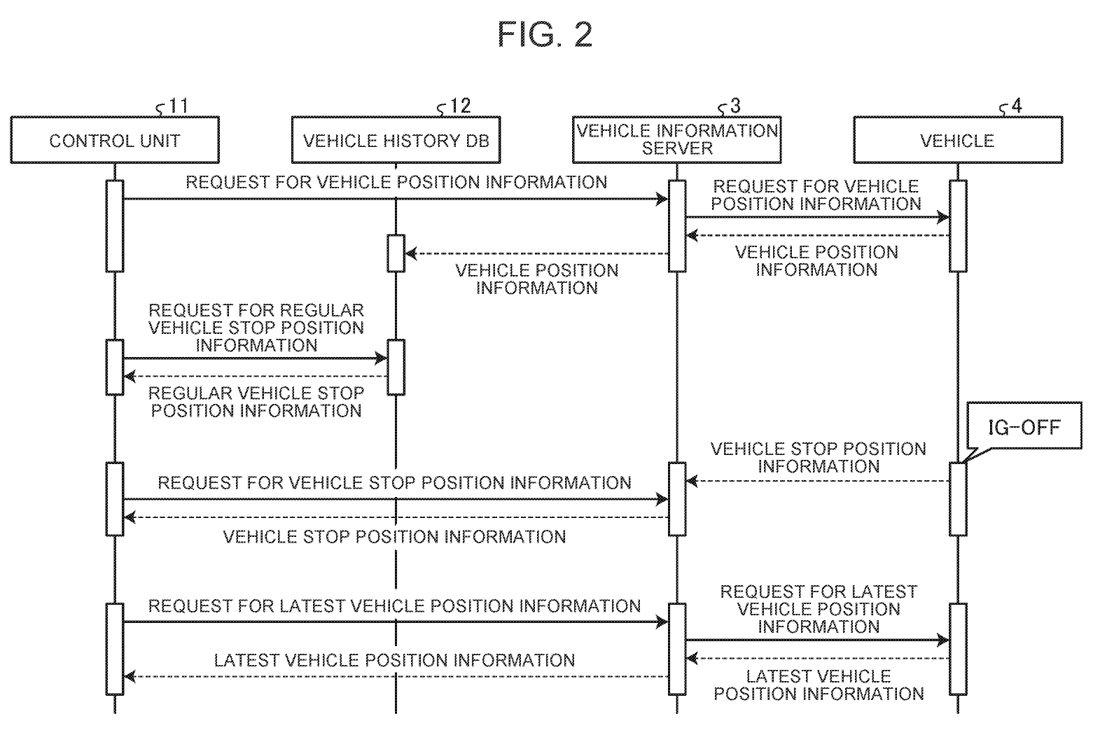

One example of exchange of information among the credit collection server 1, the vehicle information server 3, and the vehicle 4 will be described with reference to FIG. 2.

The control unit 11 of the credit collection server 1 transmits a request for the vehicle position information to the vehicle information server 3, for example, on a fixed cycle. Subsequently, the vehicle information server 3 forwards the received request for the vehicle position information to the vehicle 4. In response, the vehicle 4 transmits the vehicle position information detected by the positioning unit 43 to the vehicle information server 3. Subsequently, the vehicle information server 3 forwards the received vehicle position information to the vehicle history DB 12 of the credit collection server 1.

With meeting of the engine start lock requirement, for example, as a trigger, the control unit 11 transmits a request for the regular vehicle stop position information to the vehicle history DB 12, and acquires the regular vehicle stop position information from the vehicle history DB 12.

When the ignition has turned off (IG-OFF), the vehicle 4 transmits the vehicle stop position information detected by the positioning unit 43 to the vehicle information server 3. Subsequently, with meeting of the engine start lock requirement, for example, as a trigger, the control unit 11 transmits a request for the vehicle stop position information to the vehicle information server 3, and acquires the vehicle stop position information from the vehicle information server 3.

With meeting of the engine start lock requirement, for example, as a trigger, the control unit 11 transmits a request for the latest vehicle position information to the vehicle information server 3. Subsequently, the vehicle information server 3 forwards the received request for the latest vehicle position information to the vehicle 4. In response, the vehicle 4 transmits the latest vehicle position information detected by the positioning unit 43 to the vehicle information server 3. Subsequently, the vehicle information server 3 forwards the received latest vehicle position information to the vehicle history DB 12 of the credit collection server 1.

### Process in Credit Collection Server

One example of the flow of a process in the credit collection server 1 will be described with reference to FIG. 3. The following description will be given based on a premise that the engine start lock requirement (e.g., the user defaulting on a debt) is met at the point of starting the process.

First, the control unit 11 transmits a request for the regular vehicle stop position information to the vehicle history DB 12 (step S1) to acquire the regular vehicle stop position information (step S2). Subsequently, the control unit 11 transmits a request for the vehicle stop position information on the vehicle 4 to the vehicle information server 3 (step S3) to acquire the vehicle stop position information (step S4).

Subsequently, the control unit 11 transmits a request for the latest vehicle position information to the vehicle information server 3 (step S5) to acquire the latest vehicle position information (step S6). Subsequently, the control unit 11 determines whether the three positions respectively included in the regular vehicle stop position information, the vehicle stop position information, and the latest vehicle position information are within the predetermined range (step S7).

When it is determined in step S7 that the three positions are within the predetermined range (Yes in step S7), the control unit 11 permits activation of the engine start lock (step S8) and transmits a request for activation of the engine start lock to the vehicle information server 3 (step S9). Thus, the request for activation of the engine start lock is forwarded from the vehicle information server 3 to the immobilizer 42.

Subsequently, the control unit 11 acquires information on success or failure of the activation of the engine start lock from the vehicle information server 3 (step S10). Subsequently, the control unit 11 determines whether the activation of the engine start lock has succeeded based on the information on success or failure acquired in step S10 (step S11).

When it is determined in step S11 that the activation of the engine start lock has succeeded (Yes in step S11), the control unit 11 completes the current process. On the other hand, when it is determined in step S11 that the activation of the engine start lock has failed (No in step S11), the control unit 11 returns to processing of step S1. Examples of cases where activation of the engine start lock fails include a case where a request for activation of the engine start lock could not be transmitted from the vehicle information server 3 to the immobilizer 42 due to communication failure etc., and a case where the immobilizer 42 malfunctioned.

Here, when it is determined in step S7 that the three positions are not within the predetermined range (No in step S7), the control unit 11 prohibits activation of the engine start lock (step S12) and returns to processing of step S1.

### Process 1 in Vehicle Information Server

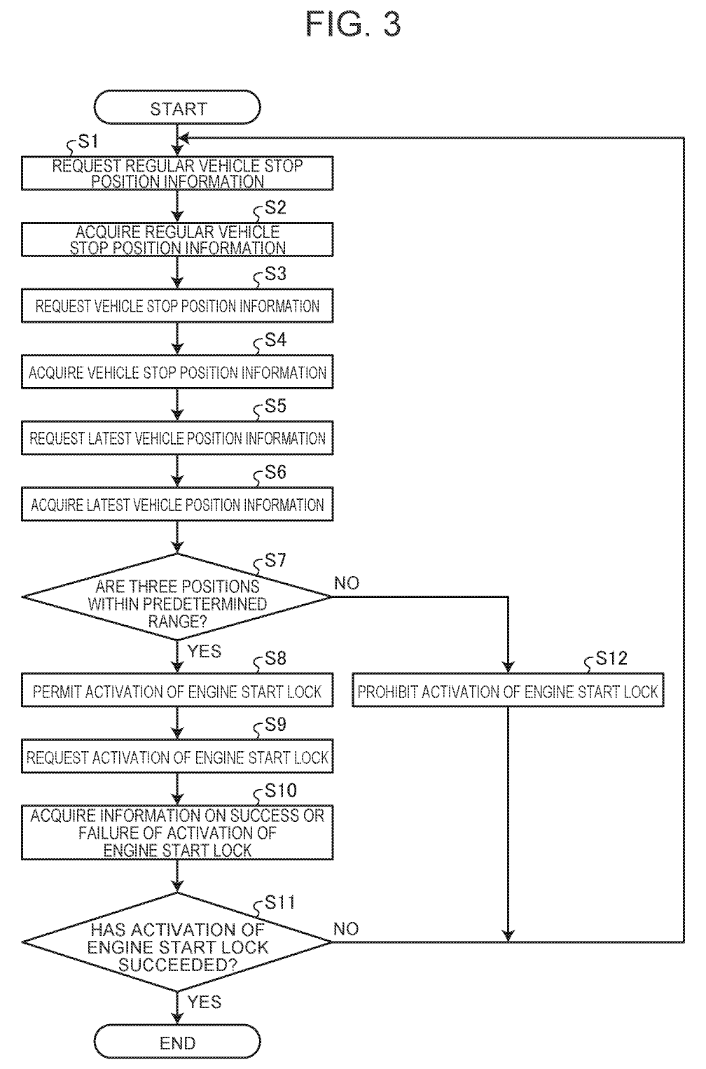

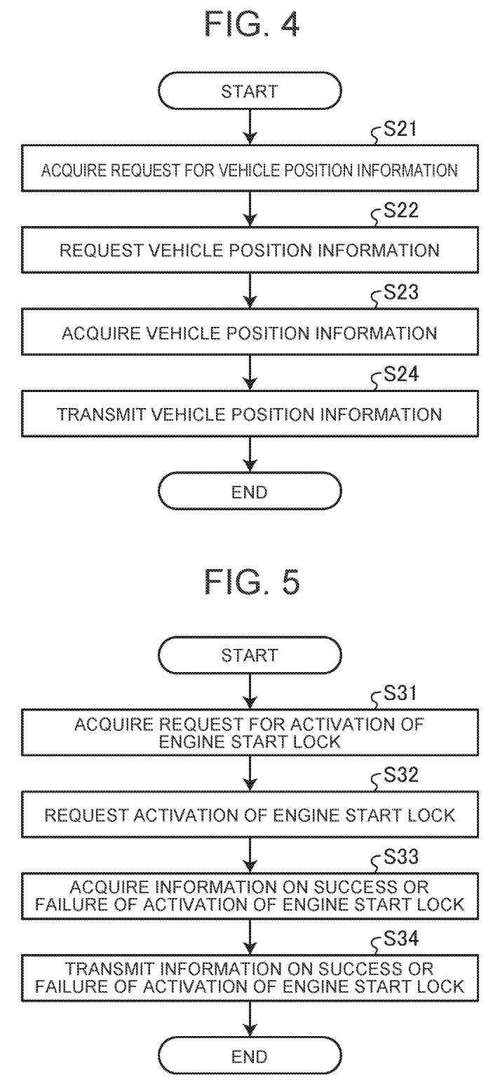

One example of a flow in the vehicle information server 3 when transmitting the vehicle position information to the credit collection server 1 will be described with reference to FIG. 4.

First, the control unit 31 acquires a request for the vehicle position information from the credit collection server 1 (step S21). Subsequently, the control unit 31 transmits the received request for the vehicle position information to the vehicle 4 (step S22). Subsequently, the control unit 31 acquires the vehicle position information from the vehicle 4 (step S23). Subsequently, the control unit 31 transmits the acquired vehicle position information to the credit collection server 1 (step S24), and completes the current process.

### Process 2 in Vehicle Information Server

One example of a flow in the vehicle information server 3 when performing activation of the engine start lock of the vehicle 4 will be described with reference to FIG. 5.

First, the control unit 31 acquires a request for activation of the engine start lock from the credit collection server 1 (step S31). Subsequently, the control unit 31 transmits the received request for activation of the engine start lock to the vehicle 4 (step S32). Subsequently, the control unit 31 acquires information on success or failure of the activation of the engine start lock from the vehicle 4 (step S33). Subsequently, the control unit 31 transmits the acquired information on success or failure of the activation of the engine start lock to the credit collection server 1 (step S34), and completes the current process.

### Process 1 in Vehicle

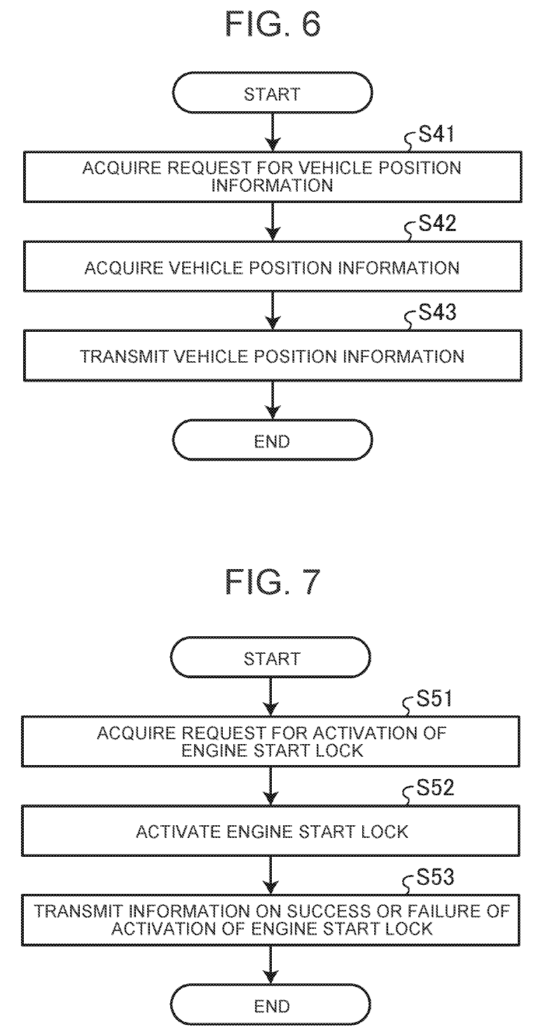

One example of a flow in the vehicle 4 when transmitting the vehicle position information to the vehicle information server 3 will be described with reference to FIG. 6.

First, the ECU 41 acquires a request for the vehicle position information from the vehicle information server 3 (step S41). Subsequently, the ECU 41 acquires the vehicle position information from the positioning unit 43 (step S42). Subsequently, the ECU 41 transmits the acquired vehicle position information to the vehicle information server 3 (step S43), and completes the current process.

### Process 2 in Vehicle

One example of a flow in the vehicle 4 when performing activation of the engine start lock will be described with reference to FIG. 7.

First, the ECU 41 acquires a request for activation of the engine start lock from the vehicle information server 3 (step S51). Subsequently, the ECU 41 performs activation of the engine start lock by controlling the immobilizer 42 (step S52). Subsequently, the ECU 41 determines whether the activation of the engine start lock has succeeded or failed based on, for example, a status of operation of the immobilizer 42, and transmits information on success or failure of the activation of the engine start lock to the vehicle information server 3 (step S53), and completes the current process.

### Process 1 in Vehicle History DB

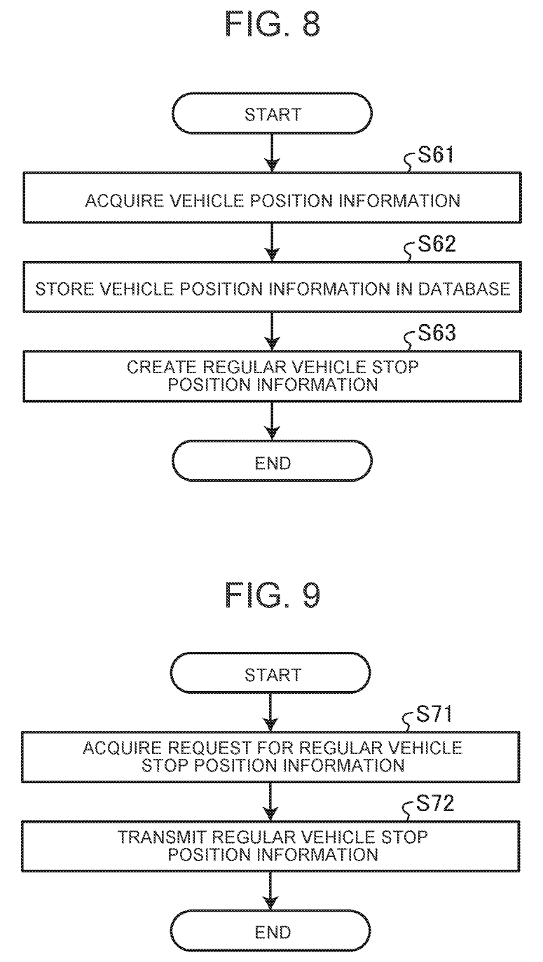

One example of a flow in the vehicle history DB 12 when creating the regular vehicle stop position information will be described with reference to FIG. 8.

First, the vehicle history DB 12 acquires the vehicle position information from the vehicle information server 3, for example, on a fixed cycle (step S61), and stores the vehicle position information (step S62). Subsequently, the vehicle history DB 12 creates the regular vehicle stop position information by analyzing the vehicle position information stored in the vehicle history DB 12 (step S63), and completes the current process.

### Process 2 in Vehicle History DB

One example of a flow in the vehicle history DB 12 when transmitting the regular vehicle stop position information to the control unit 11 will be described with reference to FIG. 9.

First, the vehicle history DB 12 acquires a request for the regular vehicle stop position information from the control unit 11 (step S71). Subsequently, the vehicle history DB 12 transmits the regular vehicle stop position information to the control unit 11 (step S72), and completes the current process.

The vehicle control device according to the embodiment having been described above determines whether to activate the engine start lock by comparing the regular vehicle stop position of the vehicle 4 (e.g., at home or workplace) and the latest vehicle position information. Thus, determination on activation of the engine start lock of the vehicle 4 can be more safely performed.

Further effects and modified examples can be easily derived by those skilled in the art. Therefore, broader aspects of this disclosure are not limited to the specific detailed and representative embodiment that has been presented and described above. Thus, various changes can be made without departing from the sprit or scope of the general concept of this disclosure that is defined by the attached claims and equivalents thereof.

For example, the description has been given based on the premise that the credit collection server 1 functions as the vehicle control device in the embodiment, but the vehicle 4 itself may function as the vehicle control device. In this case, the vehicle 4 may include the functions of the control unit 11 of the credit collection server 1 and the vehicle history DB 12. In the vehicle control device according to the embodiment, part of the processes in the credit collection server 1 and the vehicle information server 3 may be taken charge of by the vehicle 4.

For example, both of the following (1) and (2) may be performed in the credit collection server 1 or may be performed in the vehicle 4. Or the following (1) may be performed in the vehicle 4 and the following (2) may be performed in the credit collection server 1:

(1) Requesting activation of the engine start lock

(2) Determining whether to activate the engine start lock of the vehicle

While the credit collection server 1, the credit management server 2, and the vehicle information server 3 have been described as separate devices in the embodiment, the credit collection server 1, the credit management server 2, and the vehicle information server 3 may be formed by one, two, or four or more devices.

What is claimed is:

1. A vehicle control device comprising a processor configured to:
acquire regular vehicle stop position information indicating a regular vehicle stop position of a vehicle from a database configured to store history information on a vehicle stop position of the vehicle;
when it is detected that the vehicle has stopped, request latest position information on the vehicle;
acquire the latest position information on the vehicle;
when the vehicle meets a prespecified requirement for engine start lock, determine whether to activate the engine start lock of the vehicle by at least comparing the regular vehicle stop position information and the latest position information; and
when it is determined to activate the engine start lock, activate the engine start lock.

2. The vehicle control device according to claim 1, wherein the determining whether to activate the engine start lock includes determining to activate the engine start lock when the regular vehicle stop position information and the latest position information are within a predetermined range.

3. The vehicle control device according to claim 1, wherein:
the detecting that the vehicle has stopped includes receiving a signal indicating that the vehicle has stopped and vehicle stop position information indicating a position at which the vehicle has stopped; and
the determining whether to activate the engine start lock includes determining to activate the engine start lock when the regular vehicle stop position information, the latest position information, and the vehicle stop position information are within a predetermined range.

4. The vehicle control device according to claim 1, wherein the regular vehicle stop position information is information about a position at which the vehicle has stopped a predetermined number of times or more times within a predetermined period.

5. The vehicle control device according to claim 1, wherein the regular vehicle stop position information is information about a position that has been pre-registered by a user or an owner of the vehicle through an information processing terminal.
